(19) United States
(12) Patent Application Publication
(10) Pub. No.: US 2012/0247879 A1
(43) Pub. Date: Oct. 4, 2012

(54) ABSEILING DEVICE

(76) Inventors: Ulrich Kowatsch, Leonberg (DE); Peter Stabel, Oberstenfeld (DE); Marcell Kempf, Tamm (DE)

(21) Appl. No.: 13/515,589

(22) PCT Filed: Dec. 13, 2010
(86) PCT No.: PCT/EP10/07575

§ 371 Date: Jun. 13, 2012

(30) Foreign Application Priority Data
Dec. 19, 2009 (DE) 20 2009 017 159.0

(51) Int. Cl. A62B 1/14

(52) U.S. Cl. 188/65.3; 188/65.5

(57) ABSTRACT

The invention relates to an abseiling device for braking a load (16, 34) guided on a rope (14), the rope (14) running through the abseiling device (10) over a distance (22) in a friction guided manner, at least one section of the distance (22) being guided via a part (25) which can be moved from a load free starting position relative to a housing of the abseiling device (10), said part creating a force on the rope (14) dependent on the weight of the load (16) when a load is suspended, characterized in that a manually actuable adjustment unit (29) is provided, with which the moveable part (25) can be moved into the starting position in which the movable part (25) can apply no or only a small force from the moveable part (25) to the rope (14).

The invention relates to an abseiling device for braking a load guided on a rope, in which the rope passes through the abseiling device along a section in a frictionally guided manner, wherein at least one portion of the section is guided by a part that can be moved from an unloaded starting position relative to a housing of the abseiling device and that, when a load is suspended, exerts a force on the rope that is dependent on the weight of the load.

Such an abseiling device is already known from DE 10 2007 030 360 A1. It is characterized in that it automatically adapts to the weight of the load to be lowered and can be used for a large bandwidth of load weights without manual intervention.

The known abseiling device can be used both for a so-called reciprocating operation and for once-through lowering of a load. In a reciprocating operation, the abseiling device is fastened at the point from which the load will be lowered. This can be a part of a building, for example. Next, loads are attached to each of the two ends of the rope and are lowered in alternation. For once-through lowering, of a person from a building, for example, the rope is fed from a rope reservoir to the abseiling device. The abseiling device glides with the load downwardly along the rope. In this operating mode, one of the rope ends is fastened at the point from which lowering will take place.

Often it is not possible to attach the abseiling device or the rope end in the immediate vicinity of the point from which lowering will take place. In many cases it can therefore be more favorable to attach the abseiling device to a pillar, for example, in the interior of a room than to the window frame from which lowering will take place. In such cases it is desirable to be able to pass the rope through the abseiling device quickly and without frictional losses until the actual lowering point, that is, a window frame or balcony, for example, is reached. The load-dependent braking mechanism of the abseiling device should not take effect until the load starts to move downward.

The problem addressed by the present invention is therefore that of refining the known abseiling device in such a way that the braking mechanism of said abseiling device can be disabled.

The problem is solved according to the invention by an abseiling device of the initially mentioned type in that it comprises a manually actuatable adjustment device via which the movable part can be moved into the starting position in which the movable part can apply no force or only a small force to the rope.

In the abseiling device according to the invention it is therefore now possible to temporarily disable the friction acting on the rope via manual intervention. For example, one end of the rope can be attached at a suitable point within the room and the movable part of the abseiling device can then be moved into the starting position, thereby permitting the load attached to the abseiling device to be moved quickly and without frictional loss to a window opening, from which it can be lowered. Before lowering takes place, the adjustment device is released, and so the load-dependent braking mechanism of the abseiling device becomes fully functional once more and the load glides to the ground at a defined rate of speed.

Different variants of the embodiment of the adjustment device are feasible. In a preferred embodiment, the adjustment device can be formed by at least one adjustment element, which is connected to a movable part and is accessible through an opening in the housing. The adjustment element can also be part of the movable part, of course, or separate adjustment elements that act on the movable part can be provided.

In a symmetrical design of the abseiling device in particular, it is advantageous for the adjustment device to comprise two adjustment elements, which are disposed, diametrically opposed, on the movable part, each of which is accessible through an opening in the housing or extends therethrough to the outside. Symmetrically configured abseiling devices are suited in particular for use in reciprocating operation. By providing two adjustment elements that can act on the movable part, the braking effect of the abseiling device can be manually disabled, regardless of which end of the rope the load is attached to.

However, the adjustment device can also comprise only one adjustment element, which is designed as a projection of the movable part and can be moved between two stops. In this embodiment as well, the abseiling device can have a symmetrical design overall, and can be used in a reciprocating operation.

The unloaded starting position of the movable part can be a central position. This measure also simplifies the symmetrical design of the abseiling device, which is advantageous for use in reciprocating operation. When the movable part is in the central position, the rope can pass through the abseiling device in a nearly frictionless manner.

As is the case with the abseiling device that is already known, the movable part can apply a force to the rope by pressing the rope against a surface that remains stationary. The surface that remains stationary can be the surface of a shaft that can be braked using a centrifugal brake, for example. The centrifugal brake is used as an additional braking device, which, in addition to the frictionally guided section, brakes the load as it travels downward.

If the surface of the brakable shaft comprises a V-shaped groove into which the rope can be pressed, under load, via a portion of the circumference thereof, the shaft is driven by the load without slip, thereby ensuring faultless operation of the centrifugal brake.

To increase the frictional force, the frictionally guided section can be a guide channel for the rope that is equipped with a V-shaped groove extending in the direction of the rope, into which the rope can be pressed, under load, via a portion of the circumference thereof. In addition or alternatively thereto, the surface of the guide channel can be roughened and/or profiled. The frictionally guided section can also be two-dimensional or three-dimensional. Three-dimensional guidance of the rope through the section makes a very compact design of the abseiling device possible.

If the abseiling device comprises a brakable shaft, a hand wheel can be disposed on the housing, as an additional braking device, by way of which the braking effect on the shaft can be intensified by way of a centrifugal brake, for example, up to the point of full blockage. In this manner, a load can be stopped at any arbitrary height. If a person is lowered using the abseiling device according to the invention, the person can stop or at least slow the lowering procedure at any desired height. If the shaft is completely blocked, the person being lowered has both hands free to use for other activities. The lowering procedure can then be resumed by loosening the hand wheel. Instead of a hand wheel, a lever mechanism or the like can be provided for braking or blocking the shaft.

In a preferred embodiment, the hand wheel can be screwed onto a brake drum of the centrifugal brake, wherein screwing the hand wheel in further causes the centrifugal weights of the centrifugal brake, with the friction pad thereof, to be pressed outwardly against the brake drum. Depending on the extent to which the hand wheel is screwed in, the brakable shaft is only additionally braked or is completely blocked.

To prevent the hand wheel from inadvertently being unscrewed entirely from the brake drum when the brake is released using the hand wheel, the hand wheel can be secured against such unintentional unscrewing by way of a retaining ring having a thread that turns in the opposite direction.

The state of the centrifugal brake should be inspected after every use of the device. It is advantageous when the friction pad of the centrifugal weights comprise a recess as a wear indicator. If the recess is no longer visible due to the pad having worn off, the user knows that he must replace the friction pad.

When the intention is to lower heavy loads along great distances in particular, the friction results in a considerable development of heat in the abseiling device. To allow the abseiling device to be used without protective gloves in such cases, the hand wheel can be equipped preferably with a thermally insulating cover or coating. The entire housing can also be provided with a thermally insulating coating or cover, at least in regions thereof. Further measures such as cooling slits in the housing or the like to ensure rapid heat dissipation are also possible, of course.

To allow the rope to be inserted into the frictionally guided section as exactly as possible, it should be possible to open the housing. To this end, the housing can be closed, advantageously, by a flat cover that is supported such that it can swivel about an axis perpendicularly to the surface thereof, said cover being lockable in the closed position thereof. The cover is therefore fixedly connected to the housing, thereby ensuring that it cannot be lost. The swivel axis makes it possible to easily swivel the cover to open and close the housing, and the locking in the closed position prevents the cover from being unintentionally opened. The cover can also comprise an opening that is located over a feedthrough opening in the housing when the cover is closed, thereby permitting a securing element such as a rope loop or a spring clip to be passed through both openings, said securing element providing additional protection against unintentional opening of the cover.

A preferred exemplary embodiment of an abseiling device according to the invention is explained in the following in greater detail with reference to the drawings.

They show:

FIG. 1 a longitudinal view of an abseiling device according to the invention, comprising a movable part in a central position (starting position);

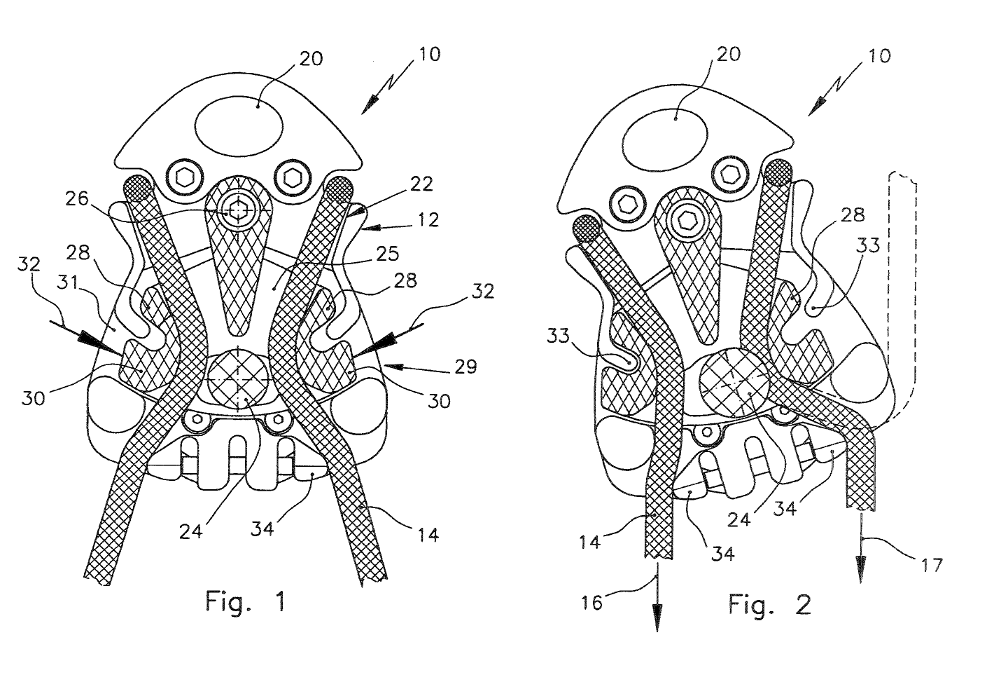

FIG. 2 a cross section of the abseiling device in FIG. 1, with a load attached, in a reciprocating operation;

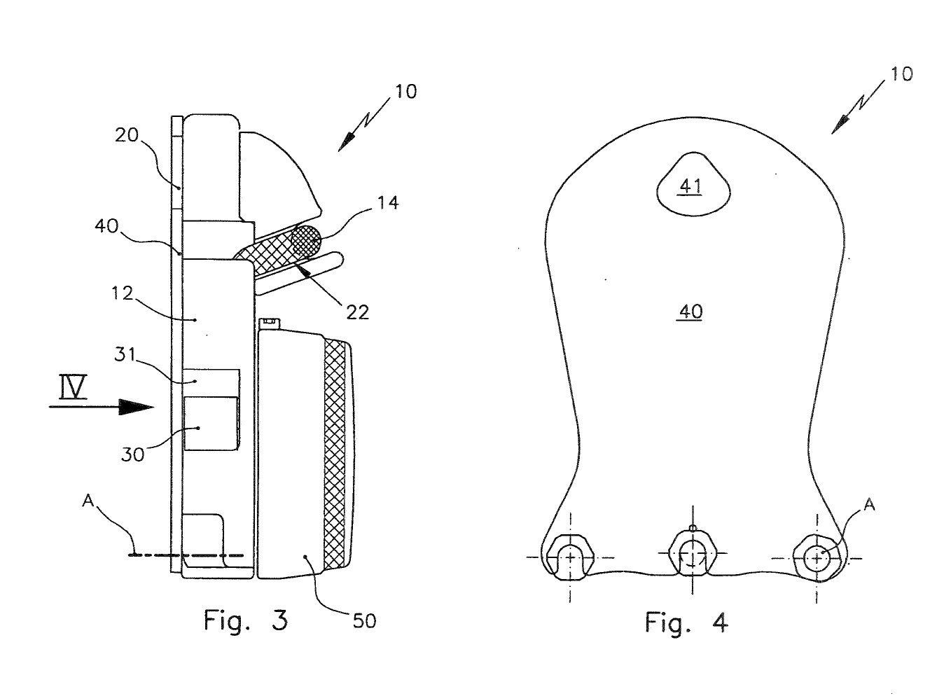

FIG. 3 a side view of the abseiling device in FIG. 1;

FIG. 4 a view of the cover side of the abseiling device in FIG. 1;

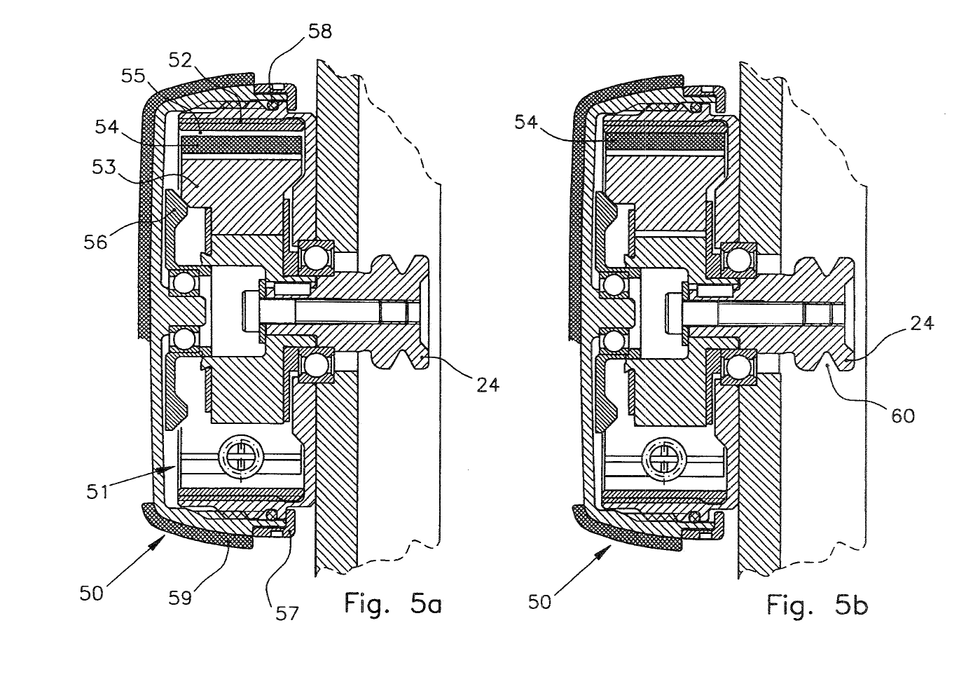

FIG. 5a, 5b a partial cross section of the brakable shaft of the abseiling device in FIG. 1, comprising a centrifugal brake and a hand wheel.

FIG. 1 shows an abseiling device 10 comprising a housing 12 through which a rope 14 is guided by way of a section 22, wherein practically no force is applied to the rope 14 in the unloaded position shown in FIG. 1. The abseiling device 10 comprises a feedthrough opening 20 at which the entire device 10 can be anchored on a building part, for example, or in which a load to be lowered can be attached. In the latter case, one of the rope ends is attached at the starting point of the lowering procedure and the load is moved along with the abseiling device 10 downward along the rope 14. The frictionally guided section 22 of the rope 14 passes by a brakable shaft 24, wherein the shaft 24 can be braked preferably by way of a centrifugal brake. In addition, a portion of the frictionally guided section 22 extends through a movable part 25, which is mounted such that it can swivel about a swivel axis 26. A displaceable mounting of the part 25 would also be feasible, however. In the position shown in FIG. 1, the swivelable part 25 is located in the unloaded starting position thereof, which is a central position in this case, from which it can be swiveled in both directions. The movable part 25 comprises two jaws 28, which form a portion of the frictionally guided section 22 between themselves and the brakable shaft 24, which is fixedly mounted on the housing 12. In the central position of the swivelable part 25 shown in FIG. 1, no force is applied to the rope 14 in this portion of the section 22. The rope 14 can be easily pulled through the housing 12 by hand. To also allow this central position shown in FIG. 1 to be manually selected at any time, the abseiling device 10 comprises an adjustment device 29, which, in the example shown, is formed by two adjustment elements in the form of outwardly curved sections 30 of the jaws 28 of the movable part 25, which are accessible from the outside through openings 31 in the housing 12. The adjustment elements 30 can be acted upon in the directions of the arrows 32, thereby allowing the angular position of the movable part 25—to which the adjustment elements 30 are attached—about the rotational axis 26 to be influenced in the desired manner. In the example shown, the adjustment elements 30 are recessed into the housing 12, although they could also be routed through the openings 31 to the outside, that is, they would extend laterally beyond the housing 12.

FIG. 2 shows the abseiling device 10 in a reciprocating operation. The symmetrical configuration of the housing 12 and the swivelable part 25 and the section 22 for the rope allows loads to be lowered in alternation at both rope ends 16, 17, which are indicated by arrows in this case. In the example shown in FIG. 2, the load hangs at rope end 16. The housing 12 is attached via the feedthrough opening 20 at a point from which the load will be lowered. Suspending the load at the rope end 16 causes the entire device 10 to swivel about the feedthrough opening. The movable part 25 also swivels. It is swiveled toward the left by the load, thereby generating a load-dependent force on the jaw 28, said force pressing the rope 14 against the shaft 24. The weight of the load suspended at the rope end 16 therefore determines the pressing force with which the rope 14 is pressed against the shaft 24 and, therefore, how strongly the rope 14 is braked as it passes through the housing 12. The swivel motion of the movable part 25 is limited by stops 33 in the housing 12.

In addition, jaws 34 are disposed on the housing 12, which prevent the movable part 25 from being braked by the rope 14 in the unloaded position thereof, in that the housing is swiveled against the direction caused by the load. If the jaws 34 were not present, the rope end 17 would be redirected to a lesser extent and could swivel the movable part 25 back via the jaw 28.

FIG. 3 shows the abseiling device 10 in a side view. This depiction clearly shows that the section 22 for the rope 14 is three dimensional, that is, it extends in more than one plane. The lateral housing openings 31 and one of the adjustment elements 30 of the adjustment device 29 are also shown. A hand wheel 50 is also mounted on the housing 12, the function of which is explained in greater detail with reference to FIGS. 5a, 5b. The housing 12 is closed on the back side thereof by a cover 40, which is mounted such that it can swivel about an axis A. As shown in particular in the backside view of the device 10 in FIG. 4, the cover 40 also comprises a feedthrough opening 41 in the region of the feedthrough opening 20 of the device 10. A spring clip, for example, can therefore be passed through the openings 20 and 41, by way of which the device 10 can be fastened in a fixed position or to which a load to be lowered can be attached.

The spring clip simultaneously provides the cover with additional protection against unintentional opening.

FIGS. 5a, 5b show a partial cross section of the shaft 24, at which a centrifugal brake 51 is disposed. The centrifugal brake 51 comprises at least one centrifugal weight 53, which is provided with a friction pad 54 on the outer side thereof. In the open position of the brake 51, which is shown in FIG. 5a, an air gap is provided between the friction pad 54 and a brake drum 52. This means that the shaft 24 can rotate in a non-braked manner. When a certain rotational speed is exceeded, the centrifugal weight is carried outwardly and comes to bear via the friction pad 54 thereof against the brake drum 52, thereby braking the shaft 24, as shown in FIG. 5b.

The brake 51 can also be actuated using a hand wheel 50, however, which is screwed onto the brake drum 52 from the outside by way of a right-hand thread. The hand wheel 50 can be screwed further onto the shaft 24 from the position shown in FIG. 5a. If this action is carried out by the user of the abseiling device, for example to reduce the lowering speed, which sets in automatically by way of the centrifugal brake, or to be able to stop during the descent, a conical contact-pressure disk 56 located on the inside of the hand wheel 50 presses the centrifugal weight 53 outwardly against the brake drum 52, thereby initiating a braking procedure independently of the rotational speed of the shaft 24.

FIG. 5b shows the hand wheel 50 in the screwed-in state, in which it brings the shaft 24 to a standstill via the brake 51.

To prevent the hand wheel 50 from being inadvertently unscrewed from the brake drum 52 entirely when the centrifugal brake 51 is released, a retaining ring 57 is provided, which is screwed onto the outer edge of the hand wheel 50 via a left-hand thread. It prevents the hand wheel 50 from being loosened beyond the position shown in FIG. 5a. The ring 57 can be loosened using a tool, however, thereby permitting the hand wheel 50 to be unscrewed from the brake drum 52, in order to replace the friction pad of the centrifugal weights 53 or the brake drum 52, for example. In addition, a seal 58 is provided between the hand wheel 50 and the centrifugal brake 51, which is in the form of an O-ring in this case.

The hand wheel 50 is also provided with thermal insulation 59, thereby permitting it to be operated even when the device heats up due to the strong frictional forces that occur.

The shaft 24 is provided with a V-shaped circumferential groove 60 into which the rope 14 is pressed via a portion of the circumference thereof when it is pressed against the shaft 24 by the jaws 28 of the adjustable part 25. It is thereby ensured that the movement of the rope 14 is transferred to the shaft 24 without slip and, therefore, that operation of the centrifugal brake 51 is reliable.

1. An abseiling device for braking a load (16, 34) guided on a rope (14), in which the rope (14) passes through the abseiling device (10) along a section (22) in a frictionally guided manner, wherein at least one portion of the section (22) is guided by a part (25) that can be moved from an unloaded starting position relative to a housing of the abseiling device (10) and that, when a load is suspended, generates a force that is dependent on the weight of the load (16), characterized in that a manually actuatable adjustment device (29) is provided, via which the movable part (25) can be moved into the starting position in which the movable part (25) can apply no force or only a small force to the rope (14).

2. The abseiling device according to claim 1, characterized in that the adjustment device (29) is formed by at least one adjustment element (30), which is connected to the movable part (25) and is accessible through an opening (31) in the housing.

3. The abseiling device according to claim 2, characterized in that the adjustment device (29) comprises two adjustment elements (30), which are disposed, diametrically opposed, on the movable part (25), each of which is accessible through an opening (31) in the housing (12) or extends therethrough to the outside.

4. The abseiling device according to claim 2, characterized in that the adjustment device (29) comprises an adjustment element in the form of a projection of the movable part (25) that can be moved between two stops.

5. The abseiling device according to claim 1, characterized in that the unloaded starting position of the movable part (25) is a central position.

6. The abseiling device according to claim 1, characterized in that the movable part (25) exerts a force on the rope (14) by pressing the rope (14) against a surface (24) that remains stationary.

7. The abseiling device according to claim 6, characterized in that the stationary surface is the surface of a shaft (24), which can be braked preferably by way of a centrifugal brake.

8. The abseiling device according to claim 6, characterized in that the surface of the brakable shaft (24) comprises a V-shaped groove (60) into which the rope (14) can be pressed, under load, via a portion of the circumference thereof.

9. The abseiling device according to claim 1, characterized in that the frictionally guided section (22) is a guide channel for the rope (14), which is equipped, at least in regions thereof, with a V-shaped groove extending in the direction of the rope, into which the rope (14) can be pressed, under load, via a portion of the circumference thereof.

10. The abseiling device according to claim 7, characterized in that the abseiling device (10) comprises an additional braking device, more particularly a hand wheel (50), for braking or completely blocking the brakable shaft (24).

11. The abseiling device according to claim 10, characterized in that the hand wheel (50) is screwed onto a brake drum (52) of the centrifugal brake (51), wherein screwing the hand wheel (50) in further causes the centrifugal weights (53) of the centrifugal brake (51), with the friction pad (54) thereof, to be pressed outwardly against the brake drum (52).

12. The abseiling device according to claim 10, characterized in that the hand wheel (50) is prevented from being unintentionally unscrewed from the brake drum (52) entirely via a retaining ring (57), which is threaded in the opposite direction.

13. The abseiling device according to claim 10, characterized in that the friction pad (54) of the centrifugal weights (53) comprises a recess as a wear indicator.

14. The abseiling device according to claim 10, characterized in that the hand wheel (50) is equipped with a thermally insulating cover (59) or coating.
